(19) United States
(12) Patent Application Publication
(10) Pub. No.: US 2006/0026031 A1
(43) Pub. Date: Feb. 2, 2006

(54) Item rental process

(76) Inventor: Gregory John Gentling, Costa Mesa, CA (US)

Correspondence Address: John H. Lynn, Suite C 103, 2915 Redhill Ave., Costa Mesa, CA, 92626, US

(21) Appl. No.: 11/192,573

(22) Filed: Jul. 29, 2005

Related U.S. Application Data
(60) Provisional application No. 60/592,355, filed on Jul. 29, 2004.

(51) Int. Cl. G06Q 99/00

(52) U.S. Cl. 705/1; 705/9

(57) ABSTRACT

A process for a distributor to rent items comprises the steps of providing an inventory of items available for rental and establishing a membership list of customers. Each membership in the membership list may include a plurality of customers with one of the plurality of customers being designated to pay for rentals and return rented items to the distributor after a selected time. Each customer may establish a prioritized choice list of preferred items for rental. An account validation is performed for each customer having a choice list, and the inventory is checked to determine availability of items on the customer choice lists of validated accounts. A priority engine arbitrates between conflicting choices of different customers. The most preferred item that is available to each customer based upon the inventory and the customer priority is then shipped to each customer that has requested a rental.

### CROSS REFERENCE TO RELATED APPLICATIONS

Applicant claims priority based upon provisional application Ser. No. 60/592,355, filed Jul. 29, 2004 and provisional application serial number 592363, filed Jul. 29, 2004.

### BACKGROUND OF THE INVENTION

This invention relates generally to a process for renting items such as video games, tapes, DVDs, music or similar items. More particularly, this invention relates to a process for managing and controlling a multiple customer, family unit oriented item rental system.

### SUMMARY OF THE INVENTION

A process according to the invention for renting items such as video games, tapes, DVDs, music or similar items includes the steps of (a) providing an inventory of items available for rental; (b) establishing a membership list of customers; (c) allowing each customer to establish a choice list of preferred items for rental; (d) performing an account validation for each customer that has established a choice list; (e) checking the inventory to determine availability of items that are on the customer choice lists of validated accounts; (f) providing a priority engine that uses selected criteria to arbitrate between conflicting choices of different customers; and (g) shipping to each customer whose account has been validated the most preferred item on the customer's choice list that is available to the customer based upon the inventory and the customer's priority.

The process according to the invention may include allowing each membership in the membership list to include a plurality of customers with one of the plurality of customers being designated to pay for rentals and return rented items to the distributor after a selected time.

### BRIEF DESCRIPTION OF THE DRAWINGS

FIG. 1 is a flowchart of an item rental process.

FIG. 2 is a block diagram of the shipping and return procedures for items.

FIG. 3 is a front view of an inventory stock picker used in the item rental process of FIG. 1.

FIG. 4 is a side view of the inventory stock picker of FIG. 3.

FIG. 5 is a flowchart of a delayed return to inventory aspect of the process of FIG. 1.

FIG. 6 is a graph of rentals as a function of time for items having a medium trough between peaks.

FIG. 7 is a graph of rentals as a function of time for items having a longer trough between peaks.

FIG. 8 is a graph of rentals as a function of time for items having a short, or undetectable trough between peaks.

### DETAILED DESCRIPTION OF THE INVENTION

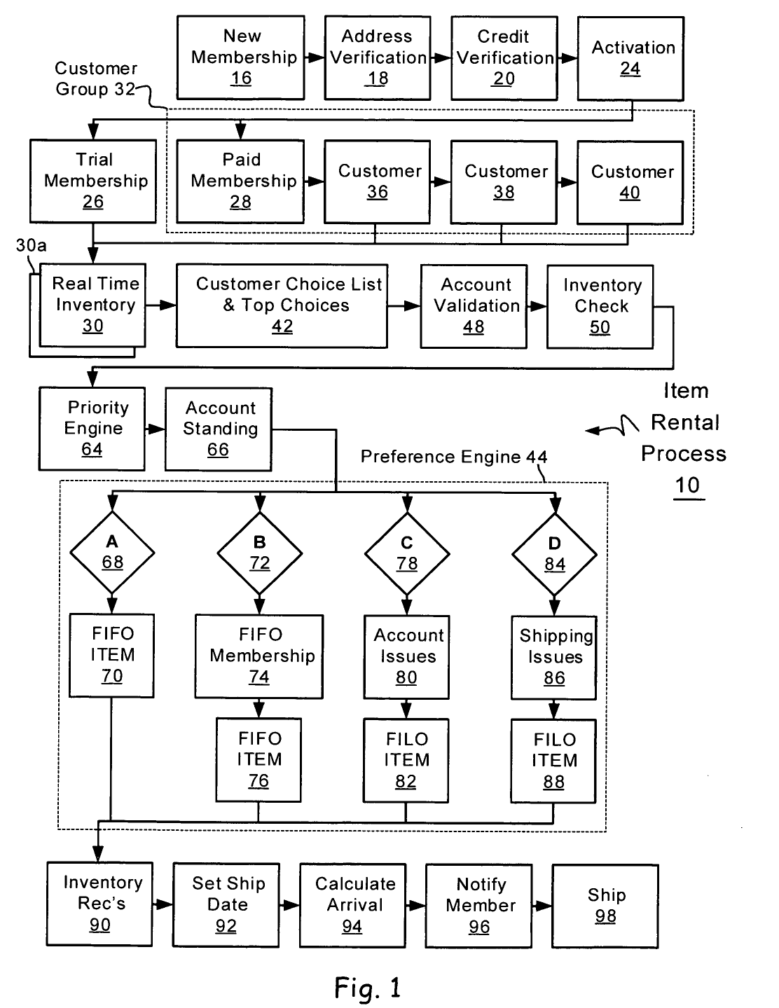

In the following description of the invention process steps are identified by a name that describes the function of each step and a reference numeral. Referring now to FIG. 1, a multiple customer, family unit oriented item rental process 10 provides for the rental of items, such as video games, tapes, DVDs, music or similar items suitable for rental business. New customers may include limited duration, free trial memberships for new customers and continuing customers may include ongoing paid subscription memberships for one or more customers.

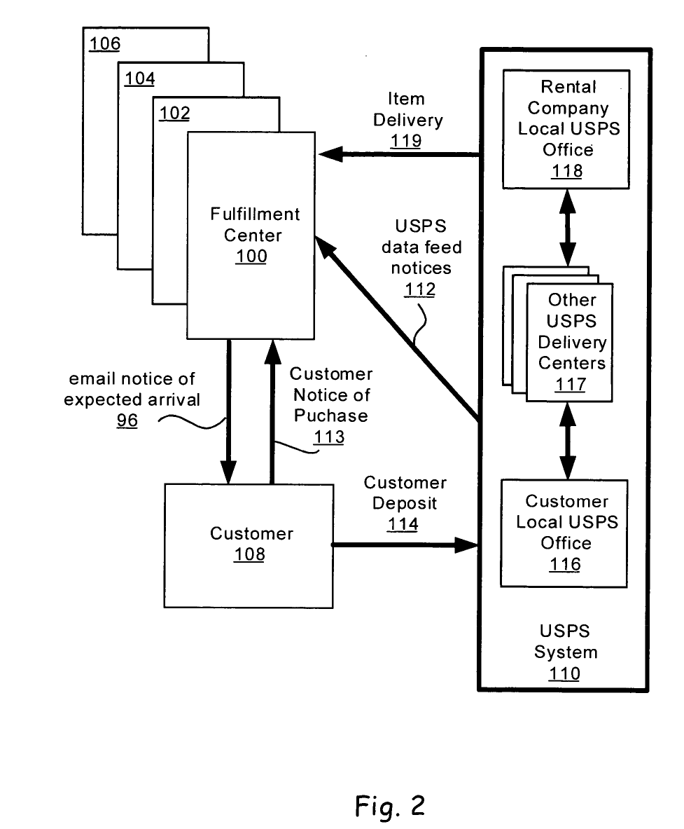

For both trial and paid memberships, member information for a new member 16 may be collected and/or verified at an address verification 18, a credit authorization 20 and a fraud prevention 22 after which customer membership activation is checked, or accomplished, in a membership activation 24. A trial membership customer 26 is then presented with an item inventory 30 to aid in the selection of items to rent. Item inventory 30 is preferably a real time inventory of at least items available to trial membership customer 26 at a primary distribution or fulfillment center for trial membership customer 26, preferably the fulfillment center geographically closest to the delivery address associated with customer 26. Distribution or fulfillment centers are described in more detail with respect to FIG. 2.

A paid membership 28 may include a single individual customer, such as a customer 36, or include a group of related customers 32 under one membership, such as customers 36, 38 and 40. For example, paid membership customer 36 may be a spouse responsible for paying for and returning rentals for both individuals of the couple as customers or a parent responsible for paying for and returning rentals for both parents and their children in a family unit or the designated member of a dorm group or fraternity or sorority responsible for paying for and returning rentals for an identified group or for similar groups. In order for a group to qualify for treatment as related customers, certain minimum criteria would apply such as a single mailing address and a designated customer financially responsible for making payments.

The combination of customers within a single paid membership has advantages for the rental company in terms of a reduced number of accounts to maintain, a single point of financial responsibility for rental fees and lost items as well as substantially reduced shipping costs to a single address. These advantages may be retained by the rental company or shared in whole or in part with the membership group.

The combination of a plurality of customers within a single paid membership has advantages for the membership group or at least for a selected customer within that group. For example, if the original or responsible customer is a parent, the parent will not have to arbitrate priorities between children or between the children and the parents. A fixed criteria such as a limitation that only one item may be allowed to be out for rental to a customer removes the competition for priority between children preferring different items, such as games. Similarly, for a married couple, the husband and wife can each have their choice lists and the next item to be delivered on a particular choice list depends on the return of the item last sent to that customer.

To implement the related customer arrangement 32, paid membership customer 36 may indicate approval for one or more related customers, such as customers 38 and 40. Thereafter, related customers 36, 38 and 40 may each have individual access to item inventory 30 with unique personal identifications and, perhaps, passwords. If membership customer 36 is a parent and related customer 38 is for example a teenage child, a specific limited inventory list 30a may be the only inventory list made available to customer 38 and may exclude undesired items such as adult rated movies and games. In other words, paid membership customer 36 may designate specific categories of rental items to be made available to related customers.

Each customer, such as trial membership customer 26, paid membership customers 36, 38 and 40, may designate one or more items from their customer specific inventory list to be identified on a customer specific choice list, such as a customer's choice list and top choices 42. For the rental company's convenience, a maximum number of items that can be included on a single customer choice list may be set. In a preferred embodiment, trial membership customer 28, as well as paid membership customers 36, 38 and 40, may each be limited to the rental of a single item at any one time so that a second item is not scheduled to be shipped to any one of these clients until the occurrence of a specified triggering event, such as:
(a) Notification by the shipper of deposit of the rented item at a shipping point for return shipment to the rental company,
(b) Purchase of the rental item by the customer or
(c) Actual receipt of the returned rental item to the rental company.

The customer's rental choices between items identified on choice list 42 may be identified by the order in which the items are added to choice list 42, or may be designated when added or may be designated later. In a preferred embodiment, customers may indicate their first, second and third choices for rental in their choice list. For convenience, the designation of the customer's choices is shown as included in customer choice list step 42 although in practice it may be advantageous to allow the customer to list all choices in one list and separately indicate the order of, for example, the top three choices. One important aspect of the related customer arrangement is that each of the customers in a group membership, such as related customer 36, 38 and 40, may chose to include the same rental item such as a currently popular game or movie on their customer specific choice list at the same or at the same or different choice levels. For example, if customers 38 and 40 are the children of customer 36, parent 36 does not have to arbitrate between children 38 and 40 with regard to who gets a particular game first. The children are allowed to set their own choice levels and any difference in when arrival time of the specified item is dependent on the children's actions and the rental companies prioritizations and preferences. Shipment of the specified item is controlled by the individual customer's specified choice levels, the triggering event as well as other rental company prioritizations and preferences are described below in greater detail.

After customer choice list 42 is established, account validation activities may be performed by an account validation step 48. Upon successful account validation in step 48, an inventory check step 50 is performed. In general, if the first choice rental item for customer 36 is available in inventory, and not already been requested by another customer with higher priority during a specified item selection interval, the item will be shipped to customer 36. The item selection interval may be any convenient interval such as the one or more times per day that stock is picked, or set aside, for shipment.

Similarly, if the first choice item for customer 36 is not available for shipment, the inventory is checked for the second choice item for customer 36, which is then shipped under the same conditions, that the first choice item would have been shipped if available. A similar procedure is followed with regard to the third choice item for customer 36 if the second choice item is not available for shipment. Arbitration between conflicting choices of different customers is handled by a priority engine 64. The number of choice levels need not be first, second and third levels of customer prioritization as described above by example, having only two levels of priority does not always provide the rental company with sufficient flexibility and having more than three levels of customer prioritization may not provide the customer with sufficiently desirable items for rental for optimal customer satisfaction.

In addition to each customer's choice levels between items, preferred embodiment priority engine 64 may determine prioritization, required by current inventory limitations, between customers who chose the same item in accordance with predetermined criteria, such as
Membership Date and Time,
Priority Date and Time,
Item ID, and
Priority level.

For example, if customer 38 and customer 40 both selected as their first choice for rental, a particular item such as item #1908 only one of which is available in inventory, the prioritization of shipment of item #1908 to one of these two customers could be determined by the customer having the earliest date and time of membership. In this example, because both customers are part of a single membership, their membership data and time would be the same. However, it is unlikely that the date and time at which each of these members selected item #1908 would happen to be the same.

Other criteria that may also be included in priority engine 64 may be a preference for delivery of items with current high rental value to trial membership customers during the limited trial period, such as a 30-day trial membership, in order to help motivate such trial membership customers to become paid membership customers. Similarly, relatively new customers may also receive the same or similar preference for the same reasons. In a preferred embodiment, as an example, priority rules may be adjusted so that during the trial membership period for trial members, and during an initial paid membership period for paid members, their priority will exceed that of customer's with earlier dates of membership.

Inventory limits are a critical aspect of item rental processes. An inventory sufficiently large so that all or substantially all customers' first choice items can always be immediately shipped is not always a cost effective inventory control process. On the other hand, an inventory limited especially with regard to highly desirable items to rent, will not be likely to maintain its customers. Inventory size, control and turnover issues are even more critical in the rental of items, such as games, videos, DVD and music with high but limited length popularity because most customers tend to want the currently popular games at the same time. These problems are made even more difficult in a rental process of the type described herein in which the length of the rental period may be customer controlled.

In a currently preferred embodiment of the rental process disclosed herein, the customer is permitted to retain the rental item as long as desired during membership. A trial membership customer may therefore keep any item rented until the end of the trial membership period while a paid membership customer may similarly keep any item rented as long as the membership fees are timely paid. The cost of the monthly membership fees are typically set high enough so that it is unlikely a customer would intentionally retain an item longer than was required for use because it would often be less expensive to purchase that item rather than continue to pay the membership rental charges, typically a monthly membership charge. In order to control inventory loss, the rental company may require that the customer at least begin the process of returning the rented item before the rental company begins the process of shipping the next item. The details of this specific type of one item out rental process are described in more detail below with respect to FIG. 2.

However, with this type of process in which the customer determines the rental period, it is difficult to use predictions of item returns to bolster or supplement item inventory. One feature of the disclosed rental process which provides at least a limited use of predictions of item returns to supplement current inventory is the shipper's notice of customer deposit of item for return discussed in greater detail below with respect to FIG. 2. Another technique for minimizing harm or loss to the rental company for items with limited current inventory is described herein with regard to a preference engine 44, which selects customers to receive highly desirable items for rental based on techniques that benefit the rental company rather than the customer. As noted above, these techniques may include techniques similar to, supporting, supplementing or even repeating the priority techniques described above but also include, based on a review of each customer's account history and standing, preferences of the rental company based on the relative quality of the customer.

For example, a customer that has a history of late payments, late returns and/or returns of damaged items is less preferred than a customer without these problems. The implementation of the techniques used in the disclosed item rental process is described in greater detail with respect to preference engine 44.

Occasionally, none of the first three choice items may be available for a particular customer. Rather than setting additional choice levels, predetermined preference criteria can be used based on customer value to the rental company, related for example to a particular customer's past actions including membership longevity, payment history, timely returns and the conditions of the items returned, in order to logically and consistently improve the quality of the rental company's customer base. Although inventory limitations that prevent a rental company from being able to provide the items chosen for rental by each customer are to be avoided, the loss to the company of these events can be reduced by use of preference engine 44.

It is important to note that the operations of priority engine 64 and preference engine 44 may be combined in a single function and/or overlap, but are separated here for the convenience of explanation and disclosure. In general, priority engine 64 is used to represent those prioritizations which are based on actions taken by the customer in obtaining membership and making requests for items to be rented while preference engine 44 generally represents preferences based on the customer's fulfillment of his obligations to the rental company such as paying the membership charges when due and returning the items rented in good condition.

After a customer's account standing, such as late payment of monthly or other membership charges has been determined, preference engine 44 may be used in order to determine if one of that customer's top three choices can be sent in spite of the priority selections made by operation of priority engine 64. Customer 68 in column A may represent a new or trial membership customer. As noted above, these customers may be given a relatively high preference so that they are motivated to join or remain as paid membership customers. The priorities between such new or trial membership customers may be considered to be at the level of first in, that is, first customer to obtain membership and/or then first to request a particular item as that customer's first choice results in first out or first to get delivery of the item. This is illustrated in FIG. 1 by a “FIFO” item step 70.

A customer 72 in column B may represent paid membership customers who are not considered new customers as represented in column A. The priorities between these ongoing paid membership customers is based on the longest membership as indicated by a FIFO membership step 74 and then by the first to order the particular item as illustrated by a FIFO item step 76. Customer's in column A, such as a customer 68, are preferred over customers in column B, such as customer 72, in order to build up and enhance the growth of the rental business.

A customer 78 in column C represents paid membership customers who have account issues, such as late payment of monthly membership or other fees as illustrated by an account issues step 80. These customers are less preferred than customers in columns A and B as illustrated by a “FILO” item step 82 which represents the idea that even though customer 78 may have been the first in, in that the item in question was identified as the first choice of customer 78 earlier than a competing customer, because of the account issues, customer 78 has a lower preference value and therefore is more likely to be the last out, that is, the last to receive the requested item as compared to customers in column A or B.

Similarly, a customer 84 in column D represents paid membership customers who have shipping issues, such as return of a damaged item, as illustrated by a shipping issues step 86. These customers are less preferred than customers in columns A and B as illustrated by a “FILO” item step 88 which represents the idea that even though customer 84 may have been the first in, in that the item in question was identified as the first choice of customer 84 earlier than a competing customer, because of the shipping issues, customer 84 has a lower preference value and therefore is more likely to be the last out, that is, the last to receive the requested item as compared to customers in column A or B.

Priority engine 64 attempts to resolve potential priority conflicts between members, such as members from different family memberships. For example, none of the top three priority items for membership customer 38 is currently available in inventory, but one of those items is available and already selected for shipment to another customer, such as customer X (not shown) preference engine 64 may be used to compare membership standing in step 66 between customer X and customer 38 to see who gets the item.

It should be noted that there are likely to be gradations within the preference values assigned to different types of account or shipping issues. For example, a customer whose account issue results from a single bounced checked will obviously have a higher preference value than a customer who has had more than a single bounced check. A customer who has bounced a single check recently may have a lower preference value than a customer who bounced a single check several years ago but has had a good record of subsequent payments. The particular grading of preferences within preference engine 44 both within and between account, shipping and other issues related to the relative quality of each particular customer with respect to other customers, may be adjustable to reflect the experiences of the particular rental company and may, if fact, be applied differently at different item distribution centers which are discussed in more detail below with reference to FIG. 2.

The operation of priority engine 64 and preference engine 44 serves to select which items in inventory are to be shipped to which customers so that the prioritization and preference rules are followed while maximizing the benefit to the customer of receiving their first, second or third choices as often as possible, respectively. One result of the operation of the priority and preference engines is to generate inventory recommendations 90 so that particular items that would be profitably rented if the inventory of that item were increased. These inventory recommendations may under some circumstances be implemented automatically by placing orders for the items with suitable vendors.

Once a particular item is selected for delivery to a particular customer, a deliver order may be created. Based on an estimated or set shipping date 92, from a fulfillment center as well as the estimated time required for delivery to the customer by the selected delivery service such as the United States Postal Service (USPS), the arrival date of the item to the customer can be calculated in step 94. The customer to receive the item may be notified by email of both the expected dates of shipment and/or of arrival of the specified item in Notify Member step 96 after which the item is shipped in step 98.

Referring now to FIG. 2, a fulfillment center 100 may be the only inventory and order fulfillment center for the disclosed item rental process, but it is advantageous to have a plurality of additional, geographically dispersed fulfillment centers such as centers 102, 104 and 106, in order to reduce the time to arrival of items shipped to customers, such as a customer 108. A further, particularly advantageous technique is to reduce the apparent time to arrival by the notice of expected arrival previously discussed which may take the form of an email notice such as a notice 96, discussed with reference to FIG. 1. An advantageous technique for further reducing the actual time to arrival of a selected item for a customer may be to use a deposit or receipt notice system provided by various shippers such as the USPS 110. In particular, USPS 110 will generate and send data feed notices 112 to an addressee, such as fulfillment center 100, that customer 108 has deposited an item, as shown by a deposit arrow 114, at an indicated USPS branch office for delivery to fulfillment center 100 via another USPS branch office. The USPS data feeds include indications when the item reaches each USPS delivery center including Customer Local USPS Office 116, other USPS Deliver Centers 117 and a Rental Company Local USPS 118. The item will be delivered by Rental Company local USPS 118 to the appropriate fulfillment center, such as fulfillment center 100 as indicated by item delivery 119.

In a preferred embodiment, rather than wait for actual delivery of the deposited item to fulfillment center 100, the item rental company may choose to use one or more data feed notices 112 as the proper indication that customer 108 has returned the previously rented item. In a preferred embodiment, the item rental company may use the first data feed notice 112, from Customer Local USPS Office 116, as the equivalent of an actual return of a rented item for the purposes of processing the next highest priority item on that customer's choice 42 for shipping. This approach substantially reduces the time for that customer to receive the next item to be rented by effective eliminating all (or almost all) the one-way transit time for return of the item to the rental company. Although there may be a relatively small loss of returned items resulting from losses by the shipper, customer 108 should not responsible for such losses at least with reputable shippers. If appropriate, suitable insurance can be obtained to compensate for such losses. In any event, upon receipt of notice of deposit 112, the rental process illustrated in FIG. 1 may be re-entered for customer 108 at choice list 42 so that the highest remaining customer choice level for that customer can then be processed in accordance with the priority and preference engines and other steps shown in FIG. 1.

Similarly, if the customer chooses to purchase the rental item in his or her possession, the customer provides a customer notice of purchase 113 to the appropriate fulfillment center such as center 100. Upon receipt of notice of purchase 113, the rental process illustrated in FIG. 1 may also be re-entered for customer 108 at choice list 42 so that the highest remaining customer choice level for that customer can then be processed in accordance with the priority and preference engines and other steps shown in FIG. 1.

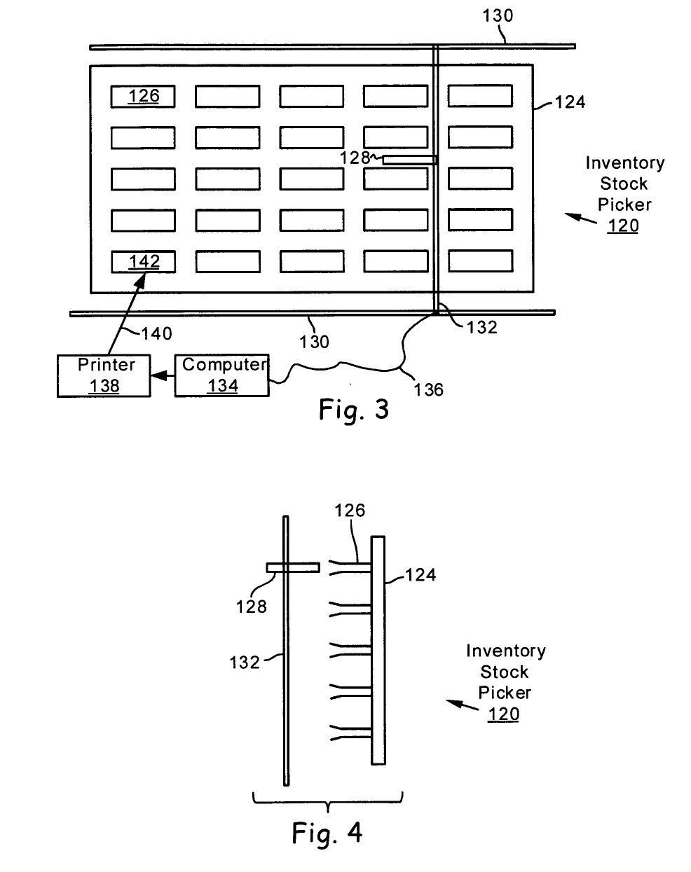

Referring now to FIG. 3, an inventory stock picker 120 includes a mounting board or back board 124 on which are mounted a series of item holders 126 that are sized to releasably hold items for rental. A picker arm 128 is mounted for vertical motion on a vertical support 132, which itself is mounted for motion on one or more horizontal supports 130. Under the control of a computer 134, the vertical and horizon position of picker arm 128 is controlled to position picker arm 128 with respect to a specific item holder 126. The size of each item holder 126 may be adjustable to fit particular sized items. In a preferred embodiment, each item holder 126 on a particular backboard 126 would be of the same size, sized to fit a particular type of rental item such as a DVD or game cartridge or videocassette.

Inventory stock picker 120 can be filled be hand, with items to be rented in an identification number or other order and/or with multiple copies of the same item located in the same area so that some measure of the inventor stock may easily be taken by inspection. In a preferred embodiment, an item being placed in (or returned to) inventor is manually or automatically positioned in stock picker 128 which is moved by computer 134 in the X, Y directions, that is, horizontally and vertically, to the next available item holder 126 into which the item is positioned by picker arm 128. The motion of picker arm 128 to insert an item into (or remove an item from) item holder 126 may be considered to be motion in the Z direction, that is, toward or away from backboard 124, and is also controlled by computer 134. When picker arm 128 positions the item in an item holder 126, the location of that item holder is listed in computer 134 together with an identification number of the particular item stored at that location so that computer 134 maintains an inventory of the items together with their locations so that inventory stock picker 120 can also be used to fulfill orders.

In particular, referring now also to FIG. 1, real time inventories 30 and 30a may be maintained by a database of items for rent. In a preferred embodiment, real time inventories 30 and 30a may include an identification of the number of each type of item available as well as a listing of those additional items, not in current inventor, which have been rented and/or are expected to be returned shortly in response to an email or other notice of deposit by customer 112 (shown in FIG. 2) and/or are in the process of being purchased in response to inventory recommendations 90 or by some other mechanism. An inventory database in computer 134 may also provide data for inventory check 50 which may indicate only those items in current inventor. Inventory stock picker 120 may be operated by computer 134 in response to ship indication 98 in order to select the required item or items for shipment to customers.

Picker arm 128 may be equipped with an item identification reader, such as a bar code reader, in order to determine or verify the identification of each item which is appropriately marked with the identification information, in order to permit inventory stock picker 120 to properly place each item in inventory and then remove it there from. The use of identification marked on each item and an identification reader, in a preferred embodiment permits computer 134 to not only print convenient item shipping containers, such as postal bags, but also to verify that the correct item is being positioned in the shipping container printed with the correct information for shipping that item to the customer intending to rent that item. In particular, the shipping container printed by printer 138 may be transported by transport mechanism 140 of any convenient configuration, into a position, such as location 142 on backboard 124. Picker arm 128 may then be operated by computer 134 to move in the Z direction (or any other combination of directions) in order to position an item selected from item holder 126 into the printed and ready for shipping, shipping container.

Computer 134, which may be single computer, a network of co-located computers or a wide area network of computers associated with each distribution centers 100,102, 104 and 106. Computer 134 may be programmed to notify each client or member, via notify member step 96 shown in FIG. 1, at a predetermined step between Set Ship Date 92 and Ship 98, that a particular item is being shipped to that customer and preferably the expected date of arrival of that item.

Referring now to FIG. 4, inventory stock picker 120 is shown in side view in which one referred embodiment of item holder 126 is shown as a pair of spring loaded clips arranged at a distance suitable for releasably holding items. Picker arm 128, riding on vertical support 132 may move in the Z direction toward item holder 126 to place an item in item holder 126 or remove it there from.

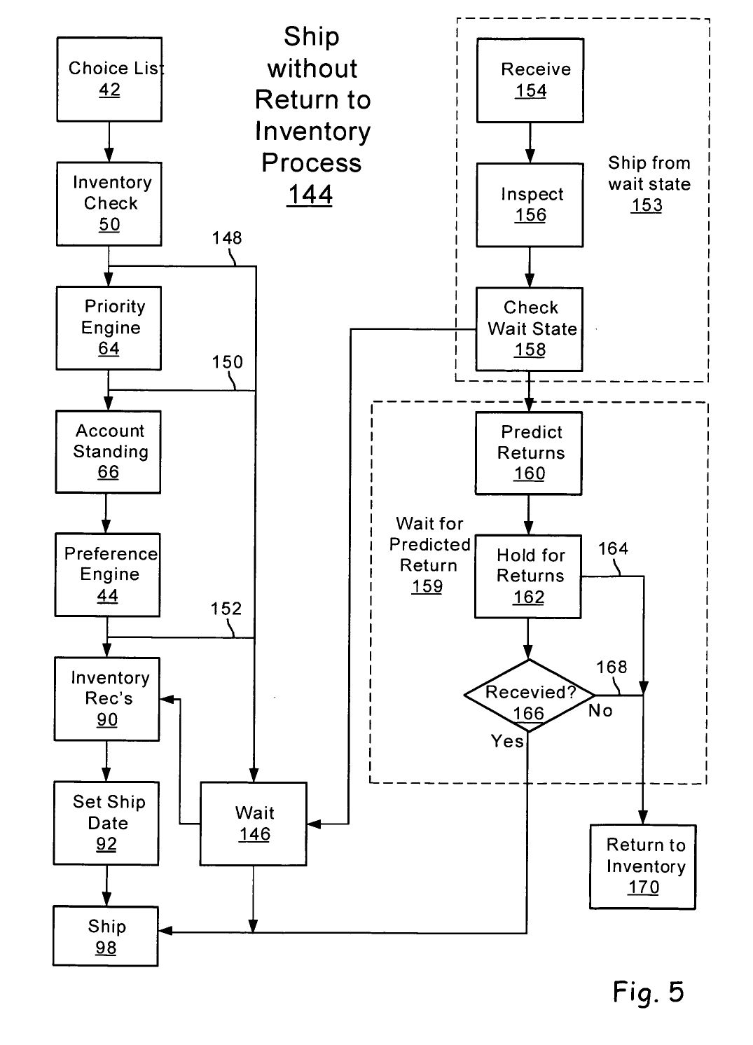

Referring now to FIG. 5, a delayed return to inventory process 144 illustrates a technique for reducing the cost of turning around received items by selectively shipping certain items rather than first returning them to inventory. As shown in FIG. 1, major aspects of selecting items to ship include evaluation of each customer's choice list 42, inventory check 50 and priority engine 64 for determining which of two or more customers would receive a specific item based on the customer's longevity or other priority if the inventory was not sufficient to ship the item to all customers requesting that item. Thereafter, after that customer's standing is checked in account standing 66, preference engine 64 may be used to determine which of two or more customers would receive a specific item based on the rental company's preference for the competing customers resulting from accounting or shipping issues for one or more of those customers. As noted above with reference to FIG. 1, priority engine 64 and preference engine 44 may be combined. After appropriate review of the inventory for recommendations for increase or decrease of selected item inventory in step 90, a shipping date may be established in step 92 and on that date the item would be shipped as shown in step 98.

For those customers whose top choices were not able to be shipped because the appropriate item inventory was not available, an additional step called wait step 146, may be used to minimize the time required, and costs incurred, before the selected can be shipped. For example, if inventory check 50 indicates that a particular item could not be shipped to a particular customer as a result of an inventory shortage, that customer's identification number together with the requested item number may be added via a path 148 to wait state 146. If as a result of preference engine 44, that item was ultimately shipped to that customer, the customer's identification number and requested item number would be deleted from wait state 146.

Similarly, when it was determined as a result of priority engine 64 that a particular item would not immediately be sent to a particular customer requesting that item, the customer and item identifications could be added via path 150 to wait state 146. Further, if priority engine 64 and preference engine 44 are separately implemented, when it was determined that a particular item would not be sent to a particular customer requesting that item, the customer and item identifications could be added via a path 152 to wait state 146. There are many other similar paths that could result in customer and item identification numbers being added to wait state 146 as an indication that specific items would be shipped to specific customers if such item were available in inventory. It is important to note that the information concerning the items in wait state 146 that would be shipped if available is useful for determining recommendations in step 90 for adding those items to inventory as indicated by a path link 154.

In a preferred embodiment, after returned items are received and inspected in steps 154 and 156, ship from wait state process transmit/receive demodulator electronics module 146 is used via check wait state 158 to determine if the just-received item is waiting to be shipped to a different customer by checking the contents of wait state 146. If the just received item is listed in wait state 146, it may immediately be shipped in step 98 and removed from wait state 146. If the just received item is not in wait state 146, it may be returned to inventory 170 or processed by predicted return loop 159 described below. One of the major benefits of ship from wait state loop 153 is the reduction in time and cost to ship an item to a renting customer by shipping that item without first returning that item to inventory.

Another technique for reducing the time and cost to ship an item to a renting customer is illustrated in predicted return loop 159. If a particular item would be shipped to a customer if the customer to whom the item is expected to be shipped when an item previously rented is returned, predicted return loop 159 may calculate when to expected the return of the item. Although the disclosed item rental process does not require that items be returned within a specified time, but rather that a rented item must be returned before the next requested item is shipped, it has been determined that the average times for returns can be predicted at least for two identifiable categories of renters. One of these categories of renters may be called “high turns” or “high velocity” renters in that rented items are returned more frequently than average.

In the game renting environment, “high velocity” games are those highly popular games that are rented out quickly and for which there is a high demand for rental. It has been observed that certain game renters demonstrate similar characteristics in that they return, or buy, games after only a short rental period. It is believed that high velocity renters are those relatively sophisticated renters who return games quickly in order to maximize the value of their membership. For example, these renters may rent games as a way to preview those games they wish to buy and quickly determine to buy or return a game in order to maximize the number of games they can preview with a single membership.

Another identifiable category of renter may be the average renter who is reasonably methodical about renting and, on average, returns items on a fairly predictable basis. This category of renter may be distinguished at least from the unpredictable renter based on historical data. Although there may be various other identifiable categories of renters based on the time on average required for the return of a rented item, identifying one or both of these first two categories of renters is sufficient to permit the effective operation of wait for predicted loop 159. In this loop, received and inspected items which are not shipped as a result of check wait state 158, may be withheld from inventory as a result of predicted returns step 160.

In predicted returns step 160, choice lists 42 may be checked for all, or a subset of all, customers to determine if the just returned item would be shipped, or would be in wait state 146, if the customer requesting the just returned item had already returned the previously rented item and if so, when the renting customer is predicted to return the previously rented item. For example, fast or “high velocity” renters may return items on average at about 9 days after rental while slower or average renters may return items on average at about 15 days after rental. These averages may be predicted more accurately for different categories of items. Returning again to the game rental example, the return of highly popular games rated for example as “AAA” rated games may be more accurately predicted for high velocity renters than games in other categories. Similarly, the geographical location of the renter may play a part in the time period or accuracy of the predicted return. It is preferable that the game rental company use its own history and experience with renters to determine the category of renter, the predicted period for return and other qualifying or disqualifying factors in order to provide accurate predictions of returns.

If as a result of predicted returns step 160, it is predicted that a just returned item is to be shipped to a particular customer predicted to return a previously rented item in a predetermined period, such as the same day as the just returned item is received, the just returned item may be held without return to inventory, for example, in hold for returns step 162. If not, the just returned item may be placed in inventory via path 164 and returned to inventory step 107. If the item is received in the predetermined period, it may be shipped to the requesting customer via shipping step 98. If the item is not received in the predicted period, it may be returned to inventory via path 168 and returned to inventory step 170.

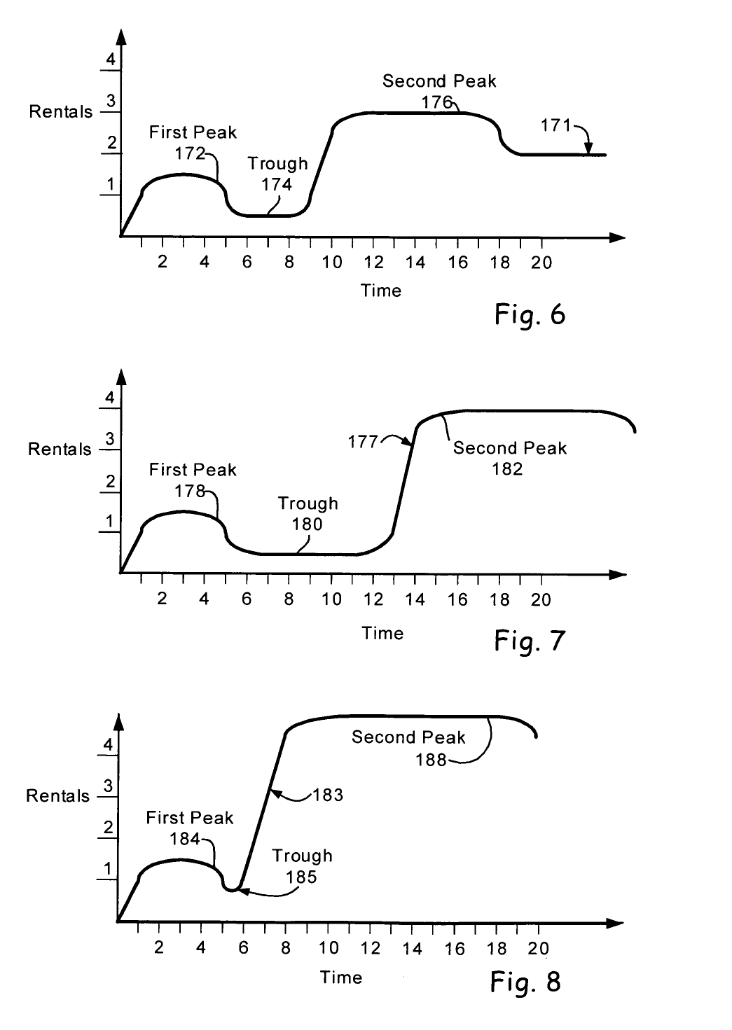

Referring now to FIGS. 6-8, it has been recognized that on average, newly released units such as new games, tend to have a double peak of the number of units rented over a preliminary time period. In particular, many such items reach a first peak, followed by a trough of medium, longer or sometimes very short duration, followed by a second peak in the number of units rented at any one time. In particular, it has been recognized that the length of the trough is a useful predictor for the relative size of the second peak. As described below in greater detail with respect to FIGS. 6-8, an average length trough may typically result in a second peak somewhat greater than the first peak while a longer than average trough may result in a substantially greater second peak. However, an extremely short trough may indicate a very substantially greater second peak.

By determining rental histories for a particular genre or type of rental unit and evaluating other data such as subjective impressions of advertisements and published evaluations or responses to the use of particular items being rented, it is possible to develop exemplars of these three different patterns of rentals to detect and predict the second peaks for various items in order to more accurately control item inventory.

Referring now in particular to FIG. 6, a graph 171 shows rentals as a function of time for items having a medium trough between peaks. The ordinate of graph 171 represents the number of rentals of a particular item, shown in relative units each representing, for example 10's or 100's of items rented. The abscissa of graph 171 represents the time period over which a particular item is rented, shown in relative units each representing for example, a day or a week. Graph 171 shows that a first peak 172 occurs between time units 1 through 5 with the peak number of items rented on the order of about 1.5 units. The number of units rented between time units 5 through 9 is much lower and is identified as a trough 174, which extends about 4 time units, with the number of units rented during this period on the order of 0.5 rental units. The number of units rented from time period 10 through time period 18 is on the order of about 3 units and is identified as a second peak 176.

Referring now in particular to FIG. 7, a graph 177 shows rentals as a function of time for items having a relatively longer trough between peaks than represented by the graph in FIG. 6. Graph 177 shows that a first peak 178 occurs between time units 1 through 5 with the peak number of items rented on the order of about 1.5 units. For convenience, the first peaks in the graphs shown in FIGS. 6-8 have been normalized, that is, the number of rental units for each first peak is shown as the same number of units although this may not be the actual case when comparing the graphs of two different rental items. This approach, however, makes it more convenient to disclose and describe the important aspects of these graphs, that is, that the duration of the trough is a predictor of the ratio of the second peak to the first peak. The number of units rented between time units 5 through 13 is much lower and is identified as a trough 180, which extends about 8 time units. The number of units rented from time period 14 and on is on the order of about 4 units and is identified as a second peak 182.

Referring now in particular to FIG. 8, a graph 183 shows rentals as a function of time for items having a relatively short, or even undetectable trough, between peaks. Graph 183 shows that a first peak 184 occurs between time units 1 through 5 with the peak number of items rented on the order of about 1.5 units. The number of units rented between time units 5 and 6 may be lower and is identified as a trough 185, which extends a relative short time. The number of units rented from time period 7 and on is on the order of about 5 units and is identified as a second peak 188.

It is important to note from FIGS. 6-8, that longer trough 180 between first and second peaks 178 and 182, when compared to trough 174 between first and second peaks 172 and 176, is a predictor of a higher ratio of the second peak to the first peak. This prediction may be used in inventory recommendation step 90 shown in FIG. 1 to indicate a more substantial increase in inventory after trough 180 in FIG. 7 than after trough 174 in FIG. 6. It is believed that the longer trough represents a more substantial build up of positive feedback leading toward item rental requests than the short trough.

However, it is also important to note that very short troughs between peaks can indicate a very popular rental item rather than an unpopular one. It may be desirable to use historical and other data to attempt to distinguish between the short trough of the type shown as trough 174 in FIG. 6, which indicates a relatively lower second peak, and the very short trough of the type shown as trough 185 in FIG. 8. With this anomaly considered, the length of the troughs can be used to improve profitability by aiding the inventory purchase recommendations. The lengths of the troughs can be determined in various ways, one of which is to determine by inspection or mathematically the time period between times when the rental volume makes a substantial negative rate change to the time when the sales volume makes a substantial positive rate change.

1. A process for a distributor to rent items including video games, video tapes and digital video discs, comprising:
providing an inventory of items available for rental;
establishing a membership list of customers;
allowing each customer to establish a choice list of preferred items for rental;
performing an account validation for each customer that has established a choice list;
checking the inventory to determine availability of items that are on the customer choice lists of validated accounts;
providing a priority engine that uses selected criteria to arbitrate between conflicting choices of different customers; and
shipping to each customer whose account has been validated the most preferred item on the customer's choice list that is available to the customer based upon the inventory and the customer's priority as determined by the priority engine.

2. The process of claim 1 wherein each membership in the membership list may include a plurality of customers with one of the plurality of customers being designated to pay for rentals and return rented items to the distributor after a selected time.
